(19) United States
(12) Patent Application Publication
(10) Pub. No.: US 2026/0146877 A1
(43) Pub. Date: May 28, 2026

(54) MAGNETIC-INDUCTIVE FLOWMETER

(71) Applicant: Endress+Hauser Flowtec AG, Reinach (CH)

(72) Inventors: Beat Tschudin, Reinach (CH); Fabian Steiner, Unterentfelden (CH); Philipp Stooss, Diegten (CH)

(21) Appl. No.: 18/719,975

(22) PCT Filed: Dec. 7, 2022
(86) PCT No.: PCT/EP2022/084826

§ 371 Date: Jun. 14, 2024

(30) Foreign Application Priority Data
Dec. 16, 2021 (DE) 10 2021 133 548.5

(51) Int. Cl. G01F 1/58

(52) U.S. Cl. CPC G01F 1/584

(57) ABSTRACT

A magnetic-inductive flow measuring probe includes: a metal tube having a tube opening in a tube wall; two measurement electrodes for forming galvanic contact with a flowing medium and for tapping an induced voltage in the medium, wherein at least one of the two measurement electrodes is arranged in a second tube end; a magnetic field-generating device arranged at least sectionally in a tube interior; and a housing at least partially made of thermoplastic material, wherein the housing includes a housing opening into which a first tube end extends, wherein the housing includes at least one projection extending radially toward the tube interior and into the tube opening to form a form-fitting connection between the tube and the housing.

### CROSS-REFERENCE TO RELATED APPLICATIONS

The present application is related to and claims the priority benefit of German Patent Application No. 10 2021 133 548.5, filed Dec. 16, 2021, and International Patent Application No. PCT/EP 2022/084826, filed Dec. 7, 2022, the entire contents of which are incorporated herein by reference.

### TECHNICAL FIELD

The present disclosure relates to a magnetic-inductive flow measuring probe for insertion into an opening of a pipeline through which a flowable medium flows, and for determining a flow velocity-dependent measured variable of a flowable medium.

### BACKGROUND

Magnetic-inductive flowmeters are used for determining the flow rate and the volumetric flow of a flowing medium in a pipeline. A magnetic-inductive flowmeter has a magnet system that generates a magnetic field perpendicular to the direction of flow of the flowing medium. Single coils are typically used for this purpose. In order to realize a predominantly homogeneous magnetic field, pole shoes are additionally formed and attached such that the magnetic field lines run over the entire pipe cross-section substantially perpendicularly to the transverse axis or in parallel to the vertical axis of the measuring pipe. A measurement electrode pair that contacts the medium and is attached to the lateral surface of the measuring pipeline taps an electrical measurement voltage or potential difference which is applied perpendicularly to the direction of flow and to the magnetic field and occurs when a conductive medium flows in the direction of flow when the magnetic field is applied. Since, according to Faraday's law of induction, the tapped measurement voltage depends upon the velocity of the flowing medium, the flow rate and, with the inclusion of a known tube cross-section, the volumetric flow can be determined from the induced measurement voltage.

In contrast to a magnetic-inductive flowmeter, which comprises a measuring tube for conducting the medium with an attached device for generating a magnetic field penetrating the measuring tube and with measuring electrodes, magnetic-inductive-flow measuring probes are inserted with their metallic tube enclosing the measuring electrodes and the magnetic field generating device into a lateral opening of a tube line and fixed in a fluid-tight manner. A measuring tube is no longer necessary. The above-mentioned measuring electrodes and device for generating the magnetic field penetrating the measuring tube on the lateral surface of the measuring tube are omitted and are replaced by a device for generating the magnetic field arranged inside the tube and in the immediate vicinity of the measuring electrodes, and are designed such that an axis of symmetry of the magnetic field lines of the produced magnetic field perpendicularly intersects the front face or the face between the measurement electrodes. In the prior art, there are already a plurality of different magnetic-inductive flow measuring probes. EP 0 892 251 A1, for example, teaches a magnetic-inductive flow measuring probe with a front plate closing the housing at the end—which plate is designed as a spherical cap—and a device arranged in the housing for generating a magnetic field passing through the front plate. The device comprises a coil that is slid onto a cylindrical coil core, which acts as a coil carrier, and field return bodies. Two pin-shaped measuring electrodes are fixed in the front panel and are covered by the device for generating the magnetic field in the longitudinal direction of the housing. In addition to the tube, magnetic-inductive flow measuring probes usually have a housing made of plastic in which the electronic components for operating the magnetic-inductive flowmeter are arranged. The housing is usually connected to the tube via a bayonet, screw, press, and/or clamp connection.

### SUMMARY

The object of the present disclosure is to provide an alternative resilient connection between the housing and the tube in contact with the medium.

The object is achieved by the magnetic-inductive flow measuring probe according to present disclosure.

The magnetic-inductive flow measuring probe according to the present disclosure for insertion into an opening of a pipeline through which a flowable medium flows and for determining a flow velocity-dependent measured variable of a flowable medium comprises:
a metallic tube with a first tube end portion and a second tube end portion in contact with the medium,
   wherein the tube has at least one tube opening in a tube wall in the first tube end portion;
at least two measuring electrodes for forming a galvanic contact with the medium and for tapping an induced voltage in the flowing medium,
   wherein at least one of the at least two measuring electrodes is arranged in the second tube end portion;
a magnetic field generating device for generating a magnetic field penetrating at least the second tube end portion,
   wherein the magnetic field generating device is arranged at least sectionally in the interior of a tube;
a housing to accommodate electronic components,
wherein the housing has a housing body formed at least partially from thermoplastic plastic,
wherein the housing body has a housing body opening into which the first tube end portion extends,
   wherein the housing body has at least one projection which extends, in particular radially, in the direction of the tube interior and into the at least one tube opening to form a form-fitting connection between the tube and the housing body.

The mechanical connection of the housing to the tube is realized in the first tube end portion. In this region, there is also at least the one tube opening—which can, for example, be designed as a through-hole, a blind hole, or an impression—and at least one projection—which can, for example, be designed as a web—which extends into or through the tube opening. If a force acts upon the tube and/or the housing, the at least one projection at least partially absorbs this force.

The measuring arrangement in a process plant according to the present disclosure comprises:
a container, in particular a pipe, for carrying a medium, with an opening in a lateral surface;
a magnetic-inductive flow measuring probe according to the present disclosure, which is arranged in the opening.

Advantageous embodiments of the present disclosure are the subject matter of the dependent claims.

One embodiment provides that the housing body comprise a polycarbonate.

One embodiment provides that the housing comprise a seal, in particular a sealing ring,
wherein the seal, in particular the sealing ring, is arranged in a seal receptacle of the housing body and is pressed in between an outer wall of the tube and a counterpressure surface of the housing body.

The seal, in particular the sealing ring, is configured to absorb manufacturing tolerances of the tube, the housing body, and the projection when making the connection, and to minimize the movement clearance between the tube and the housing.

The provision of the seal is also particularly advantageous in terms of haptics, since it prevents a pivot point from forming on the projection, which causes the tube to wobble in the housing body opening even under the slightest forces.

In one embodiment, the housing comprises a housing cap that is configured to hold the seal, in particular the sealing ring, in position,
wherein the housing cap borders the seal receptacle in a longitudinal direction of the tube.

The advantage of the design is the supporting property of the housing cap, which prevents the seal from slipping out of the seal receptacle when the tube or the measuring point vibrates or the temperature changes.

Another advantage of this design is that no specially formed seal is required; instead, an O-ring is sufficient to compensate for the tolerances and fix the housing to the tube.

In one embodiment, the housing cap is at least form-fittingly connected to the housing body.

The advantage of the design is that the form-fitting connection means that no permanent force acts upon the housing body or the receptacle for the housing cap, which would otherwise cause the housing body to age more quickly at this point.

In one embodiment, the housing has a housing interior,
wherein the housing body has a collar which extends at least sectionally into the housing interior,
wherein the collar comprises the at least one projection.

One embodiment provides that the at least one projection be formed by means of staking.

Staking is a manufacturing process for joining two components, where one component is made of plastic and the other component is made of metal. This allows a permanent form-fit, force-fit, and in some cases also integral connection, without additional cleaning effort, and thus a high degree of design freedom in the conception of components.

One advantage of staking is that it can be used to compensate for manufacturing tolerances in the tube opening or the tube itself.

One embodiment provides for the projection to be formed by stamping a recess in a surface, facing the inner housing, of the collar.

One embodiment provides for the projection to be formed by stamping a recess in a surface, facing the outer wall of the tube, of the collar.

The two embodiments listed above form two alternatives for manufacturing the at least one projection. In the first cited case, a heated punch is used to create a recess in the surface, facing the inner housing, of the collar. By melting and displacing the material towards the inside of the tube, a projection is formed through the tube opening, which creates the form-fitting connection. In the second case, the punch is positioned in the inside of the tube and guided through the tube opening. The material of the housing body swells radially into the inside of the tube from the surface, facing the outer wall of the tube, of the collar and forms the projection that creates the form-fitting connection.

One embodiment provides for the housing body, in particular the collar, to have a protruding stop body,
wherein the tube has a receptacle for the stop body,
wherein the stop body is arranged in the receptacle, in particular in the slot,
wherein the stop body is configured to reduce shearing forces on the at least one projection, which are caused at least by a torque on the housing body.

The stop body is used to reduce the shear forces acting upon the at least one projection—which occur, for example, when a torque acts upon the housing body. If the receptacle is designed as a slot that extends parallel to the longitudinal axis of the tube, and the at least sectionally cuboid or rhombus-shaped stop body is inserted into the slot, it does not absorb any forces in the longitudinal direction. In this case, forces in the longitudinal direction are at least absorbed by the projection.

One embodiment provides that the at least one sleeve opening be designed as a slot, at least sectionally.

One embodiment provides for the slot to assume a first slot diameter D1 in a first slot section,
wherein the slot in a second slot section assumes a second slot diameter D2,
wherein the first slot diameter D1 is smaller than the second slot diameter D2.

In one embodiment, the slot extends from one edge of the tube in the longitudinal direction of the tube,
wherein the tube edge has an inclined phase for simplified insertion of a partial section of the housing body.

In one embodiment, the at least one tube opening is at least sectionally oval in shape.

In one embodiment, the housing body has a guide which extends at least sectionally along the slot to absorb a torque acting upon the housing body.

### BRIEF DESCRIPTION OF THE DRAWINGS

The present disclosure is explained in greater detail with reference to the following figures. In the figures:

FIG. 1 shows a partially sectional view of a magnetic-inductive flow measuring probe;

FIG. 2 shows a sectional view through a connecting part of a housing with a tube of a magnetic-inductive flow measuring probe according to the present disclosure;

FIGS. 3a-3c show partial detail views of three stages of a process for manufacturing the magnetic-inductive flow measuring probe according to the present disclosure;

FIGS. 4a and 4b show partial detail views of an alternative embodiment of the magnetic-inductive flow measuring probe;

FIG. 5 illustrates a measuring arrangement according to the present disclosure;

FIG. 6a shows a perspective detail view of a further embodiment of the tube opening and the connection variant of the tube with the housing body;

FIG. 6b shows a cross-section through the projection and the tube opening; and

FIG. 7 illustrates an alternative embodiment of the tube opening.

### DETAILED DESCRIPTION

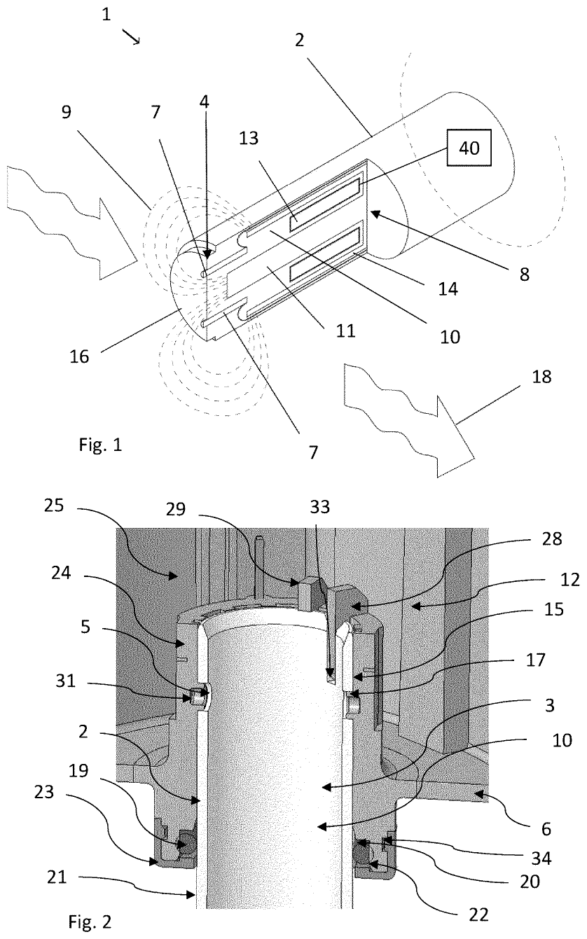

First, the measuring principle upon which the present disclosure is based is explained on the basis of the perspectival and partially sectional illustration of FIG. 1. A magnetic-inductive flow measuring probe 1 comprises a generally hollow and circular cylindrical tube 2 with a given outer diameter, which is usually metallic. The tube is adapted to the diameter of a bore, which is located in a wall of a tube line 26 (not shown in FIG. 1 but shown in FIG. 5) and into which the magnetic-inductive flow measuring probe 1 is inserted in a fluid-tight manner. A medium to be measured flows in the tube line 26, and the flowmeter 1 is immersed into the flowing medium practically perpendicularly to the flow direction of the medium, which is indicated by the wavy arrows 18. A second tube end portion 16 of the tube 2 that protrudes into the medium and comes into contact with the medium is sealed fluid-tight with a front body 16 made of insulating material. By means of a magnetic-field-generating device 8 arranged at least sectionally in a tube interior 10 of the tube 2, a magnetic field 9 extending through the second tube end portion 16 into the medium can be generated. A coil core 11, which at least partially consists of a soft magnetic material and is arranged in the tube 2, terminates at or near the second tube end portion 16. A field return with a field return body 14, which encloses a coil 13 and the coil core 11 at least sectionally, is set up to feed the magnetic field 9, passing through from the second tube end portion 16, into the tube 2 back to the coil core 11. Two galvanic measuring electrodes 7 are arranged in the front body 16 and contact the medium. An electrical voltage induced due to Faraday's law of induction can be tapped off at the measurement electrodes 7 by means of a measuring circuit. This is at a maximum if the magnetic-inductive flow measuring probe 1 is installed in the tube line such that a plane spanned by a straight line intersecting the two measuring electrodes 7 and by a longitudinal axis of the magnetic-inductive flowmeter 1 runs perpendicularly to the flow direction 18 or to the longitudinal axis of the tube line.

More than two measuring electrodes 7 can also be provided. Such variants are used, for example, for more precise conductivity measurement or for flow direction detection. An operating circuit 40 is electrically connected to the coil 13 and is configured to impress a clocked excitation signal on the coil 13 in order to thus generate a clocked magnetic field 9.

FIG. 2 shows a sectional view through the connecting part of the housing 12 with the tube 2. The magnetic-inductive flow measuring probe 1 according to the present disclosure for insertion into an opening of a container through which a flowable medium flows and for determining a flow velocity-dependent measured variable of a flowable medium comprises a metallic tube 2 with a first tube end portion 3 and a second tube end portion (4; see FIG. 1) in contact with the medium. An essential feature of the present disclosure is the tube opening 5 incorporated into a tube wall 6 in the first tube end portion 3. The depicted embodiment has two opposite tube openings, each of which has a round cross-section and is designed as a bore. However, the shape of the tube opening 5 can be freely selected.

Furthermore, the magnetic-inductive flow measuring probe 1 comprises a housing 12 for accommodating electronic components. Electronic components are an essential part of electrical circuits and can usually comprise a voltage source, electrical resistors, capacitors, coils, diodes, transistors, and integrated circuits. A distinction is made between active and passive, linear and non-linear, discrete and integrated, and analog and digital electronic components. The electronic components are part of the operating circuit, measuring circuit, and/or evaluation circuit. The electronic components can also be part of a display. The electronic components can be arranged on a printed circuit board. The housing 12 has a housing body 6, formed at least partially from thermoplastic plastic, with a housing body opening 15, into which the first tube end portion 3 extends. A suitable material for the housing body 6 is polycarbonate. In addition, the housing body 6 has at least one projection 17 which extends, in particular radially, in the direction of the tube interior 10 and into the at least one tube opening 5 to form a form-fitting connection between the tube 2 and the housing body 6. In the depicted embodiment, the housing body 6 has exactly two opposing projections, both of which are formed by staking. The formation of the projections 17 by means of staking comprises the stamping of a recess 31, which is formed as a blind hole, in a surface 30, facing the outer wall 21 of the tube 2, of the collar 24. The projections 17 are therefore hollow-cylindrical, at least sectionally.

The housing 12 also has a-seal, in particular a sealing ring 19, which is arranged in a seal receptacle 20 of the housing body 6 and is pressed in between an outer wall 21 of the tube 2 and a counterpressure surface 22 of the housing body 6. A housing cap 23 is configured to hold the seal, in particular the sealing ring 19, in position. The housing cap 23 borders the seal receptacle 20 in a longitudinal direction of the tube 2. The housing cap 23 also has a device for latching the housing cap in a provided receptacle 34 in the housing body 6. The device for latching the housing cap can be designed as an annular latching lug that latches in an annular receptacle 34 or recess in the housing body 6, or as individual segments for latching into individually provided receptacles. This ensures that the housing cap 23 is at least form-fittingly connected to the housing body 6.

Furthermore, the housing 12 has a housing interior 25 into which a collar 24 of the housing body 6 extends. The advantage of the solution is a particular compactness of the housing 12. Alternatively, the collar can also be provided outside the housing interior 25. The collar 24 is hollow-cylindrical or ring-shaped, at least sectionally. The collar 24 serves to increase the contact surface between the tube and the housing body in order to achieve a mechanically more stable connection between the tube 2 and the housing body 6. The collar 24 has at least one projection 17 to form the form-fitting connection between the collar 24 and the tube 2.

The housing body 6, in particular the collar 24, also has a stop body 28 projecting into the interior of the tube and which is located in a receptacle, in particular in the form of a slot 33. The stop body 28 is configured to reduce shearing forces on the at least one projection 17, which are caused at least by a torque on the housing body 6.

According to an advantageous embodiment, the tube has more than two tube openings, in particular three and preferably four tube openings, via each of which a form-fitting connection is created between the tube 2 and the housing body 6. The tube openings are arranged in the tube 2 in such a way that they are positioned offset by an angle greater than or equal to 60°.

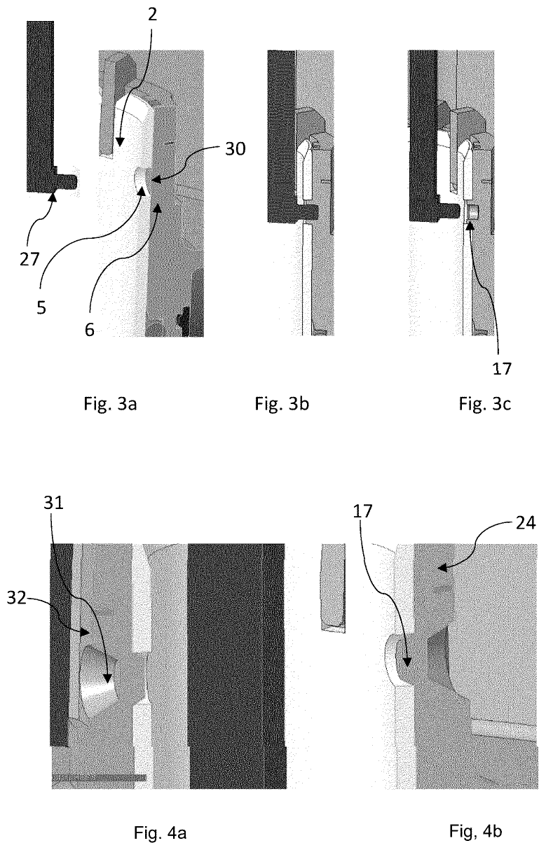

FIGS. 3a-3c show three stages of a method for manufacturing the magnetic-inductive flow measuring probe according to the present disclosure. In a first method step, a punch 27 for staking is inserted into the inside of the tube. The punch 27 has a heatable tip, which is cylindrical in the depicted embodiment. Alternatively, the tip can assume the shape of a trough. The punch 27 is heated either before or during contact with the housing body 6. When the punch 27 has been heated to the set temperature, it is passed through the tube opening 5—in the second method step—and pressed against the surface 30, facing the tube 2, of the collar. Alternatively, the punch 27 is pressed against a guide that extends in the tube opening 5. When the punch is pressed against the surface 30 in a radial direction, the melted material of the housing body 6 is also displaced radially, and the punch forms a recess in the housing body 6. This also forms the projection 17 from the melted and displaced material, which ensures the form-fitting connection between the housing body 6 and tube 2. In the last method step, the punch 27 is removed. The punch 27 can be provided with a channel through which air is let into the contact region for accelerated cooling of the tip and the melted material. What remains is a blind hole-shaped recess in the housing body 6.

According to an advantageous embodiment, two projections 17 are produced with two punches in a first pass, and two further projections 17 are produced by the two previous punches in a second pass after turning the tube 2 and cooling the previously melted material of the housing body 6.

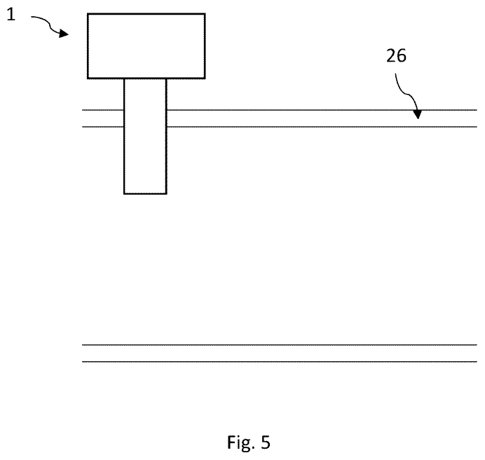

FIGS. 4a and 4b show alternative embodiments of the magnetic-inductive flow measuring probe in which the projection 17 is formed by stamping the recess 31, which is conical in the exemplary figure, into a surface 32, facing the housing interior 25, of the collar 24. In the manufacturing method, the material of the housing body is softened or melted and pressed from the housing interior 25 into or, if applicable, also through the tube opening. The projection 17 formed thereby ensures the form-fitting connection.

FIG. 5 shows a measuring arrangement according to the present disclosure in a process plant, which comprises a pipeline 26 for guiding a medium. The pipeline has an opening that is incorporated into the side of a lateral surface. A magnetic-inductive flow measuring probe 1 according to the present disclosure is arranged in the opening and is configured to determine and monitor a flow velocity-dependent measured variable.

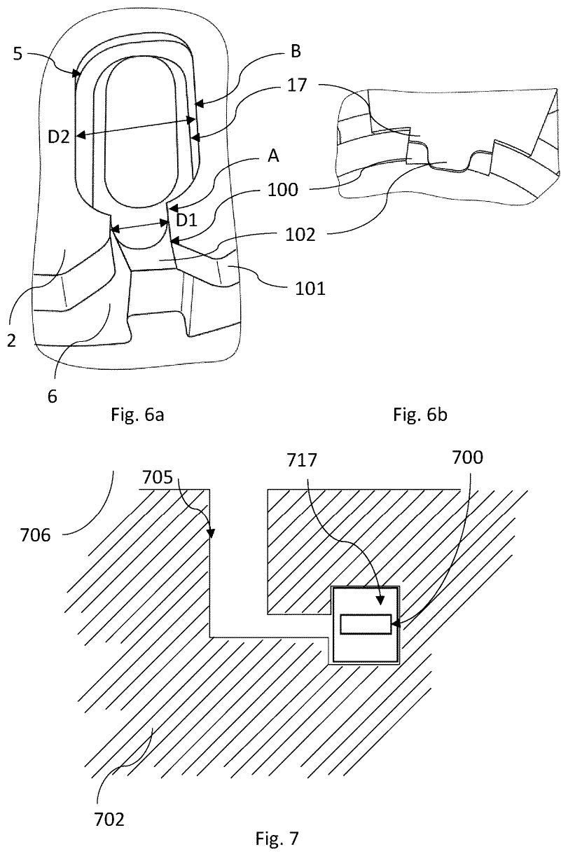

FIG. 6a shows a perspectival view of a further configuration of the tube opening 5 and the connection variant of the tube 2 with the housing body 6. The depicted tube opening 5 is formed at least sectionally as a slot 100 which extends from a tube edge 101 of the tube in the longitudinal direction of the tube. The design as a slot has the advantage that a projection or guide of the housing body can be guided along it. The depicted tube opening 5 has a key shape. For this purpose, the slot 100 has a first slot diameter D1 in a first slot section A and a second slot diameter D2 in a second slot section B. The diameter of the slot 100 can increase in steps or continuously. Both diameters differ in such a way that the first slot diameter D1 is smaller than the second slot diameter D2.

In the depicted embodiment, the tube edge 101 has an inclined phase for simplified insertion of a partial section or a guide 102 of the housing body 6. Furthermore, the tube opening in the second slot section is oval in shape.

The housing body has a guide 102 which extends at least sectionally along the slot 100, in particular along the first slot section A, for absorbing a torque acting upon the housing body 6. When connecting the tube 2 to the housing body 6, the guide 102 is guided through the slot 100 in such a way that the guide 102 extends at least partially in the first slot section A and in the second slot section B. The material of the guide 102 is melted and shaped with a heatable tip, which is essentially trough-shaped. After deformation, the housing body 6 can no longer be detached from the tube 2 without destroying the form-fitting connection, in particular the projection 17.

FIG. 6b shows a cross-section through the projection 17 and the tube opening 5. The projection 17 fits snugly against the edge of the tube in the tube opening 5. This serves to absorb the rotational forces on the housing body without creating play during the rotation of the housing body. This means that the housing body can no longer be separated from the tube 2, i.e., pulled off, without destroying the projection 17. The projection 17 is formed from the material of the guide 102. The tip used for this has the shape of a trough. This displaces the material of the guide 100 towards the edge of the tube opening 5.

FIG. 7 shows an alternative configuration of the tube opening 705, which is part of a bayonet connection. The tube opening 705 is formed in an edge region as a (longitudinal) slot, which extends in the longitudinal direction of the tube 702. At the end of the extension, the tube opening 705 is formed as a slot that extends in the circumferential direction. In an end region, the slot has a widening, similar to the embodiment in FIG. 6a. The housing body 706 has a guide 700 which is such that it can be guided through the tube opening 705 into the end region or the widening. There, the guide 700 is deformed in such a way that a projection 717 is formed which forms the form-fitting connection between the tube 702 and the housing body 706. After the guide 700 has been melted or deformed, it can no longer be guided through the guide 700, since the projection 717 blocks the mobility of the housing body 706.

1-14. (canceled)

15. A magnetic-inductive flow measuring probe for insertion into an opening of a process line through which a flowable medium flows and for determining a flow velocity-dependent measured variable of the medium, the flow measuring probe comprising:
a metallic tube including a first end portion and a second end portion, which second end portion is configured to contact the medium, wherein the tube includes a tube wall, which includes at least one tube opening in the tube wall in the first end portion;
at least two measuring electrodes, each configured to effect galvanic contact with the flowing medium and to tap an induced voltage in the medium, wherein at least one of the at least two measuring electrodes is disposed in the second end portion;
a magnetic field-generating device configured to generate a magnetic field that penetrates at least the second end portion, wherein the magnetic field-generating device is disposed at least sectionally in a tube interior of the tube;
a housing configured to accommodate electronic components, wherein the housing includes a housing body made, at least partially, of thermoplastic,
wherein the housing body includes a housing body opening into which the first end portion of the tube extends, and wherein the housing body includes at least one projection which extends radially toward the tube interior and into the at least one tube opening so as to effect a form-fitting connection between the tube and the housing body.

16. The magnetic-inductive flow measuring probe according to claim 15, wherein the housing includes a seal disposed in a seal receptacle of the housing body and pressed between an outer wall of the tube and a counterpressure surface of the housing body.

17. The magnetic-inductive flow measuring probe according to claim 16, wherein the housing includes a housing cap configured to hold the seal in position, wherein the housing cap borders the seal receptacle in a longitudinal direction of the tube.

18. The magnetic-inductive flow measuring probe according to claim 17, wherein the housing cap is at least form-fittingly connected to the housing body.

19. The magnetic-inductive flow measuring probe according to claim 16, wherein the seal is a ring seal.

20. The magnetic-inductive flow measuring probe according to claim 15, wherein the housing defines a housing interior, wherein the housing body includes a collar which extends at least sectionally into the housing interior, and wherein the collar includes the least one projection.

21. The magnetic-inductive flow measuring probe according to claim 15, wherein the at least one projection is formed by a heat staking process.

22. The magnetic-inductive flow measuring probe according to claim 21, wherein the at least one projection is formed by stamping a recess in a surface of the collar, facing a housing interior.

23. The magnetic-inductive flow measuring probe according to claim 21, wherein the at least one projection is formed by stamping a recess in a surface, facing the outer wall of the tube, of the collar.

24. The magnetic-inductive flow measuring probe according to claim 20, wherein the collar of the housing body includes a projecting stop body,
wherein the tube includes a tube receptacle configured to accept the stop body,
wherein the stop body is disposed in the tube receptacle, and
wherein the stop body is configured to reduce shearing forces on the at least one projection, which shearing forces due at least to a torque on the housing body.

25. The magnetic-inductive flow measuring probe according to claim 24, wherein the tube receptacle is configured as a slot.

26. The magnetic-inductive flow measuring probe according to claim 15, wherein the at least one tube opening is configured at least sectionally as a slot.

27. The magnetic-inductive flow measuring probe according to claim 26, wherein the slot in a first slot section assumes a first slot diameter,
wherein the slot in a second slot section assumes a second slot diameter, and
wherein the first slot diameter is smaller than the second slot diameter.

28. The magnetic-inductive flow measuring probe according to claim 26, wherein the slot extends from a tube edge of the tube in the longitudinal direction of the tube, wherein the tube edge has an inclined phase configured to facilitate insertion of a partial section of the housing body.

29. The magnetic-inductive flow measuring probe according claim 15, wherein the at least one tube opening is substantially oval in shape, at least sectionally.

30. The magnetic-inductive flow measuring probe according to claim 26, wherein the housing body includes a guide which extends at least sectionally along the slot and so as to absorb a torque acting upon the housing body.
